(19) United States
(12) Patent Application Publication
(10) Pub. No.: US 2010/0116668 A1
(43) Pub. Date: May 13, 2010

(54) MATERIAL SYSTEM AND METHOD FOR PRODUCING THE SAME

(75) Inventors: Uwe Landau, Berlin (DE); Andreas Zielonka, Schwaebisch Gmuend (DE); Rainer Haag, Berlin (DE); Michael Kraemer, Offenburg (DE); Teodora Valkova, Sofia (BG)

Correspondence Address: Workman Nydegger;1000 Eagle Gate Tower, 60 East South Temple, Salt Lake City, UT, 84111, US

(73) Assignee: FREIE UNIVERSITAET BERLIN, Berlin (DE)

(21) Appl. No.: 12/594,403

(22) PCT Filed: Apr. 3, 2008
(86) PCT No.: PCT/EP08/54032

§ 371 Date: Nov. 13, 2009

(30) Foreign Application Priority Data
Apr. 5, 2007 (DE) 10 2007 017 380.8

(51) Int. Cl. B32B 5/16; C25D 7/00; C25D 15/00; B32B 15/00

(52) U.S. Cl. 205/50; 205/109

(57) ABSTRACT

A material system having a matrix and nanoparticles embedded therein, wherein the matrix comprises at least one matrix metal, the nanoparticles have an average size of less than 50 nm and the nanoparticles have in each case at least one functional carrier. A method for producing the material system is also disclosed.

### CROSS-REFERENCE TO A RELATED APPLICATION

This application is a National Phase patent application of International Patent Application Number PCT/EP 2008/054032, filed on Apr. 3, 2008, which claims priority of German Patent Application Number 10 2007 017 380.8, filed on Apr. 5, 2007.

### BACKGROUND

The invention relates to a material system, a component and a method for producing such a material system.

From prior art, functional surfaces are know which increasingly turn out to be a constructional element via which the performance but also the costs of products are designed. Furthermore, surface coating significantly contributes already today by its material-preserving process engineering to the preservation of recourses.

Thereby, electroplating is behind the varnishing technique the most important surface technique which is indispensable for practically all relevant areas of industry. Electroplating can be performed according to the actual state of the development by using a very modern and environmentally friendly process technology.

The automotive industry looks for example urgently for new solutions for the coating of connector assemblies (contact coating) which solutions have to fulfill three essential problems:
1. Temperature stability of the contact coatings at temperatures above 200° C.,
2. low plug and pull forces (constantly increasing number of poles in the connector assembly) and
3. in particular a significantly increased resistance to abrasion.

To achieve a high resistance of abrasion in a motor vehicle, complex and heavy contact constructions are necessary which absorb vibrations occurring in the motor vehicle and avoid a destruction of the contacts of the connector assemblies. In a medium class vehicle approximately 200 to 300 plugs (according to 2000 to 3000 single contacts) are currently mounted, wherein approximately 54 millions of motor vehicles are produced world-widely each year.

Increasing the persistency of abrasion of the contact coating is an important aim of the automotive industry to save, besides an ameliorated contact safety, also material and therewith weight in the vehicle, because an increased persistency of abrasion of the contact coating would make possible a significant reduction and simplification of the complex constructions of plugs. A reduction of weight and the saving of fuel connected thereto have the highest possible priority in today's automotive industry.

Constantly increasing ambient temperatures, in particular in the engine bay, and the heat produced by the constantly increasing uptake of electric power bring the contact surfaces made of hard gold and tin used today already to the limit of their capacity. An increased abrasion of the connector contacts implies an increased emergence of electronic scrap and an increased effort in the material and energy for the contacts to be replaced. The absolute functional safety of respective contacts is a prerequisite for the high degree of use of electronics in a vehicle, in particular with respect to safety-relevant components.

It is known from prior art that properties of coating substances can be influenced positively over a wide range by the embedding of particles in the range of micrometers or in the upper range of nanometers.

Traditionally, the development of dispersion coatings is concentrated on the concomitant integration of resistant material (SiC, BN, Al₂O₃, diamond) and solid lubricants (PTFE, MoS₂, graphite, etc.). Thereby, generally particle sizes in the range of micrometers are applied. Such dispersion layers are successfully used for many years in the coating of cylinders of high performance motors as well as in the electrotechnology.

Krämer et al. (2004) (Krämer, M., Stumbé, J.-F., Grimm, G., Kaufmann, B., Krüger, U., Weber, M., Haag, R.: “Dendritic polyamines: simple access to new materials with defined treelike structures for application in nonviral gene delivery”; ChemBioChem 5 (2004), 1081-1087) describe different, partially functionalized dendritic polyamines as polymers for the formation of nanoparticles.

Krämer et al. (2005) (Krämer, M., Pérignon, N., Haag, R., Marty, J.-D., Thomann, R., Lauth-de Viguerie, N., Mingotaud, C.: “Water-Soluble Dendritic Architectures with Carbohydrate Shells for the Templation and Stabilization of Catalytically Active Metal Nanoparticles”; Macromolecules 38 (2005), 8308-8315) describe the possibility, to use nanoparticles made from partially functionalized dendritic polyamines as carrier or as stabilizing shell for metal ions or metal atoms, respectively. Thereby, the nanoparticles show a core-shell structure.

### SUMMARY

It is an object of the instant invention to positively influence the properties of a material, in particular of those of a coating by using a smaller amount of substances than known from prior art. It is another object of the invention to specify a method for producing an according material having ameliorated properties.

This object is achieved by a material system which has a matrix and nanoparticles embedded into the matrix, wherein the matrix has at least one matrix metal, the nanoparticles have an average size of less than 50 nm and the nanoparticles in each case have at least one functional carrier. The functional carrier serves for influencing the properties of the matrix in the desired sense. A material system according to an aspect of the invention can also be denoted as composite material.

The average size of the nanoparticles is to be determined in particular by transmission electron microscopy (TEM) and results from the diameter of the nanoparticles being projected onto a plane. Depending on the orientation of the nanoparticles during such a transmission electron microscopical photograph, e.g., the biggest dimension (diameter) of a nanoparticle or the smallest dimension of a nanoparticle can be observed from case to case, wherein these extremes average themselves statistically. It is also possible (and the probably most frequent case) that diameters which lie between the biggest and the smallest diameter of the nanoparticles are observed as projection during size determination. Since the nanoparticles may show a spherical form, the differences between the biggest and the smallest diameter of the nanoparticles may be comparatively small. In an embodiment, the biggest and the smallest diameter of the nanoparticles are identical.

In an embodiment, the average size of the nanoparticles is less than 40 nm, in particular less than 30 nm and lies particularly in a range of 2 to 20 nm. In this size range nanoparticles are observed in layer systems which practically consist only of surface and exhibit partially other properties than bigger particles which have besides a surface also still a significant volume. Therewith, the nanoparticles used according to an aspect of the invention differ significantly from such nanoparticles having a size of from 50 to 100 nm.

In an embodiment of the invention, the nanoparticles have in each case at least one polymer. This polymer serves in particular for the actual formation and stabilization of the nanoparticles.

In an embodiment, this polymer is a dendritically structured polymer, e.g., a dendritic polyamine.

Particularly suited polymers are polyethyleneimine, polyamidoamine and/or polypropyleneimine. Thereby, it is to be respected that the nanoparticles do not necessarily need to consist of or have, respectively, a single polymer, but can also have more than one polymer.

In an alternative embodiment of the invention, the polymer is provided with or functionalized by a functional group. In case of polyamines as polymers used, it is appropriate to perform the functionalization at the amino groups of the respective polyamine.

In an embodiment, the functional group consists of the residue of a hydrocarbon compound, in particular of the residue of glycidol, gluconolactone and/or lactobionic acid. Alternatively or additionally, the functional group can also be another polymer than that of which the nanoparticle in the actual sense consists. For this purpose, the already above-mentioned polymers like polyethyleneimine, polyamidoamine and/or polypropyleneimine are particularly well suited. The denomination “residue of a hydrocarbon compound” or “residue of a polymer”, respectively, shall clarify that the polymer, which the nanoparticles exhibit, is chemically reacted with and covalently bound to an according hydrocarbon compound or an according polymer so that the complete hydrocarbon compound or the complete polymer, respectively, are not longer present, but only a residue remains which is chemically integrated into another molecule.

In an embodiment of the invention, the nanoparticles have in each case a core which is at least partially surrounded by a shell. In this manner, functional carriers to be arranged in the inner of the core can be particularly well stabilized. E.g., the water solubility of the nanoparticles and therewith the solubility of the functional carries being arranged within the nanoparticles can be significantly increased by a suited shell. Also, the solubility in another solvent can be ameliorated in this way.

In an embodiment of the invention, both the core and the shell are formed by the polymer which the nanoparticles exhibit. I.e., only the special structure of the polymer accounts already for the fact that one can refer to a core and a shell of the single nanoparticles. This special structure of the polymer comes into account in particular by the use of polyamines like, e.g., polyethyleneimine.

In an alternative embodiment of the invention, the core of the nanoparticles is formed by the polymer, and the shell of the nanoparticles is formed by the functional group. I.e., depending on the selection of the functional group, the properties of the nanoparticles can be influenced or adjusted, respectively, or changed independently on and additionally to the properties predefined by the polymer.

In an embodiment of the invention, the at least one functional carrier is arranged in an inner area of the nanoparticles. It is explicitly remarked that more than one functional carrier, in particular not only with respect to the number, but also with respect to the kind or properties, respectively, can be part of the nanoparticles. E.g., it is thinkable that 20 atoms or ions of a first compound and 15 atoms or ions of a second compound together constitute the functional carrier which a single nanoparticle exhibits.

In an embodiment of the invention, the at least one functional carrier consists of a metal, i.e., the at least one functional carrier is formed by a metal atom or a metal ion.

In an embodiment, the metal for the functional carrier and/or the matrix metal is platinum, gold, silver, copper, cobalt, nickel, iron, tin and/or palladium. As well in case of the matrix as also in case of the functional carrier, more than one metal can be used at the same time. In doing so, numerous matrices having significantly different properties can be provided. Also, the properties can be influenced in a different fashion by the introduction of heterogeneously loaded nanoparticles. Functional carriers which consist of one or several metal(s) serve in particular for the change of the conductivity of the matrix material.

By introducing nanoparticles loaded with tin into a matrix of copper (Cu-nano-Sn), bronze can be produced which can, e.g., designed as white bronze or as yellow bronze depending on the relative ratio of both metals to each other.

Also other nanocomposites can be produced from said metals, like, e.g., nanoparticles loaded with gold in a matrix of nickel (Ni-nano-Au), nanoparticles loaded with tin in a matrix of silver (Sn-nano-Ag) or nanoparticles loaded with palladium in a matrix of silver (Pd-nano-Ag).

In an alternative embodiment of the invention, it is envisaged that the at least one functional carrier is silicon carbide, boron nitride, aluminum oxide (Al₂O₃) and/or diamond. With such functional carriers which belong to particular resistant materials, the hardness properties of the matrix can be influenced. Thereby, it can be taken into account that, e.g., nanodiamonds have an abrasion behavior which is particularly ameliorated as compared to usually dimensioned diamonds, although the hardness of nanodiamonds does not differ from that of usually dimensioned diamonds. I.e., by the introduction of functional carriers in a nanoparticle certain nanoproperties of the respective materials used as functional carriers can be additionally exploited.

To achieve properties as homogeneous as possible of the material system, the nanoparticles may essentially be uniform dispersed in the matrix. This results in the fact that also after a removal of an upper layer of the material system the properties of the layer lying underneath do not significantly differ from the removed layer so that negative effects like they occur, e.g., in case of a simple surface coating can be avoided.

For this reason, the material system is, in an embodiment of the invention, particularly well suited for the coating of a substrate. The material systems produced according to an aspect of the invention can also be transferred to industrial coating systems (e.g. reel electroplating systems) and can be used, e.g., in connector assembly systems as contact materials. This enables a reduction of weight of connector assemblies, reduces the effort in material and energy as compared to conventional contact systems and gives new impulses for the introduction of novel drive systems, e.g., of hybrid technology.

In an embodiment, a material system according to an aspect of the invention is used to coat a particularly electric or electronic component, e.g., to influence its properties with respect to conductivity, the hardness and/or further parameters in the desired way.

In an embodiment, the particularly electronic component is an electrically conductive portion of a plug, in particular a contact portion of a plug.

Besides the uses of the material systems according to an aspect of the invention in the area of electrotechnology or electronics, these can also be used for the coating of substrates with the aim to ameliorate the mechanical properties like, e.g., hardness and abrasion persistency.

The object of the invention is also solved by a method for producing a material system on a substrate, wherein the method comprises the steps of providing a substrate, of providing an electrolyte solution which has ions of a matrix metal, of producing nanoparticles, wherein the nanoparticles have an average size of less than 50 nm, of loading the nanoparticles with at least one functional carrier, of drugging the electrolyte solution with the loaded nanoparticles, of dipping the substrate into the electrolyte solution drugged with the loaded nanoparticles and of depositing the ions of the matrix metal and of the nanoparticles contained in the electrolyte solution as material system onto the substrate. In an embodiment, this deposition is carried out electrolytically or galvanically, respectively. In an embodiment, the nanoparticles to be used have the designs described above.

In order to be able to produce the nanoparticles very well, the concentration of the polymer is, in an embodiment, between 1 mol per liter and 10⁻⁷ mol per liter, in particular between 10⁻³ mol per liter and 10⁻⁶ mol per liter and especially between 10⁻⁴ mol per liter and 10⁻⁶ mol per liter.

To make a loading of the formed nanoparticles with the functional carrier possible in a certain way, the ratio between the polymer and the functional carrier during the loading is, in an embodiment, in a range of between 1:1 and 1:100. Thereby, the term “ratio” denotes a ratio of the concentrations of the respective substances. At a ratio of 1:1 the same concentrations of polymer and of functional carrier are used, at a ratio of 1:100 the functional carriers are used in a hundredfold concentration excess with respect to the concentration of the polymer. Particular suited concentration ratios between the polymer and the functional carrier lie, in an embodiment, in a range of between 1:10 and 1:50, in particular in a range of between 1:20 and 1:40 and especially in a range of between 1:24 and 1:30. Thereby, a formulation using the term “between” at this site as well as also at the preceding and succeeding sites of the instant description of invention and in the claims comprises the respectively mentioned upper and lower limits.

Particularly stable nanoparticles can be obtained by carrying out the production of the nanoparticles in a solution having a pH value between 1 and 14, in particular between 5 and 11 and especially at a pH value at approximately 10 like a pH value of between 9.8 and 10.2. The particularly suited pH value of the solution depends in each case on the polymer which is used for formation of the nanoparticles.

Nanoparticles being particularly stable and suited for the uptake of functional carriers can be obtained by using a polymer having a mean molecular weight of between 2 and 100 kDa, in particular of between 5 and 50 kDa and especially of between 20 and 30 kDa. A mean molecular weight of approximately 25 kDa is particularly suited in an embodiment.

In order to take care for a good stability of the nanoparticles, in particular of the nanoparticles loaded with the functional carriers, the electrolyte solution has, in an embodiment, a pH value of between −1 and 14, in particular of between 0 and 13 and especially of between 2 and 8. For certain systems, a pH value of, e.g., 4 to 5 has turned out to be particularly suited.

In order to achieve a deposition of the loaded nanoparticles together with the metal ions of the electrolyte solution onto the substrate, the concentration ratio between the polymer and the functional carrier during the deposition lies, in an embodiment, in a range of between 1:1 and 1:100, in particular in a range of between 1:10 and 1:40, wherein a range of between 1:20 and 1:30 and in particular a ratio of approximately 1:24 like a range of between 1:23 to 1:25 have turned out to be particularly suited in a certain embodiment.

In an embodiment, the deposition of the loaded nanoparticles and metal ions of the electrolyte solution as metal atoms of a matrix onto the substrate can be carried out if the current density used for the deposition lies in a range of between 0.1 and 20 A/dm², in particular of between 0.2 and 10 A/dm² and especially of between 0.25 and 8 A/dm². To achieve the afore-mentioned current densities, different voltages are necessary depending on the distance of the electrodes used for the deposition.

In order to perform the deposition of the loaded nanoparticles and the metal ions of the electrolyte solution onto the substrate in a certain way, the deposition is performed, in an embodiment, at a temperature between +5 and +95° C., in particular between +15 and +70° C. and especially between +30 and +50° C.

The deposition of the material systems according to an aspect of the invention can be carried out under a relative movement between the substrate and the electrolyte solution. In an embodiment, the relative velocity between the electrolyte solution and the substrate is 0 to 15 m/s, in particular 0.1 to 5 m/s and especially 0.1 to 2 m/s.

In an embodiment of the invention, the substrate forms an electrode which exhibits a metal. Thereby, the electrode can be manufactured partially or completely of the metal.

In particular platinum, gold, silver, copper, cobalt, nickel, iron, tin and/or palladium as well as their alloys are suited as metals. It is thinkable that the electrode or the substrate, respectively, consists of more than one metal.

In an embodiment, the method is used for coating a component which shall have a functional coating, i.e. a function-mediating coating. E.g., it can be used for electric or electronic components.

In order to form the material properties of the material systems deposited onto the substrate in a certain manner, the method exhibits in an embodiment of the invention an additional step of an aftertreatment which succeeds the step of depositing. In this step of aftertreatment, the position of the loaded nanoparticles being embedded into the matrix as well as their phase formation with the matrix metal can be subsequently changed, in particular by diffusion. This is in particular possible if tin-loaded nanoparticles are embedded into a matrix of copper.

In an embodiment, the aftertreatment is executed as thermal aftertreatment, whereto the material system deposited onto the substrate is heated to a temperature above room temperature.

In an embodiment, the temperatures for the thermal aftertreatment lie in the range of between +60° C. and +1000° C., in particular between +100° C. and +700° C. and especially between +200° C. and +600° C.

In order that an aftertreatment has not to be performed over the whole extension surface of the material system but is only carried out at particularly relevant sites, the thermal aftertreatment is performed in an embodiment only in a locally limited area of the deposited material system.

As well a locally limited as also a locally non-limited thermal aftertreatment can be accomplished particularly simple by means of a laser, wherein, in an embodiment, thermal aftertreatments having different energy inputs into the material system can be particularly simple realized due to numerous lasers being available on the market.

The combination of electro-chemical depositing methods and stable tailor-made core-shell nanoparticles enables the production of novel material combinations which are not producible in other ways or are producible in other ways only with a high effort. The big variation width of the available core-shell systems enables a specific adjustment to highly different electrolyte systems and establishes the possibility for the production of metal composite materials in big variety. Thereby, the possibility to produce materials far away from the thermodynamic equilibrium and therewith in an extended spectrum of properties is of particular relevance.

Thereby, one harnesses also the template effect during the interaction between the functional carrier (in particular if it is a metal) and the nanoparticle. In this circumstance, a geometric “imprint” in the nanoparticle (or in the polymer which forms the nanoparticle) is understood as template effect by which ligands for the functional carrier can be arranged on the side of the polymer in a complex-suited manner.

### BRIEF DESCRIPTION OF THE DRAWINGS

Further details of the invention shall be explained by the subsequent description of an exemplary embodiment and respective figures in more detail.

FIG. 1 shows a schematic depiction of the production of a nanoparticle loaded with functional carriers, which nanoparticle is to be used within the scope of the invention,

FIG. 2 shows the chemical structure of a first exemplary embodiment of a polymer,

FIG. 3 shows the reaction equation for the production of a second exemplary embodiment of a polymer starting from the polymer depicted in FIG. 2,

FIG. 4A shows an electron-microscopical photograph of a cross section through an embodiment of a material system according to an aspect of the invention and

FIG. 4B shows the schematic depiction of the electron-microscopical photograph of FIG. 4A.

### DETAILED DESCRIPTION

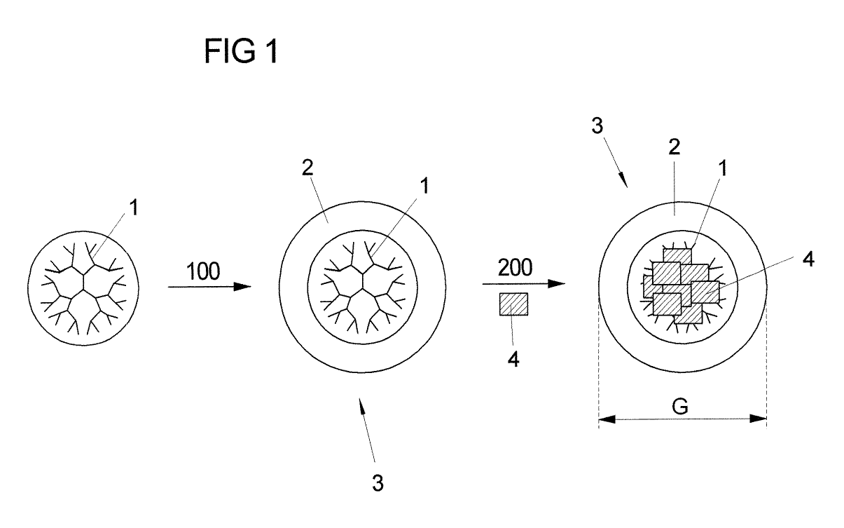

FIG. 1 shows a dendritic polyamine as polymer 1, wherein the spherical dimensions of the polymer 1 in the space are adumbrated by a sphere drawn around the polymer 1.

In a first reaction step 100, the polymer 1 is provided with a plurality of molecules of a functional group 2 at its reactive centers. Functional groups are thereby covalently bound to the polymer 1; this is not explicitly depicted in FIG. 1. After the functionalization of the polymer 1, the polymer 1 forms the core of a nanoparticle 3, whereas the functional group(s) 2 forms the shell of the nanoparticle 3. In a second reaction step 200, metal particles 4 (metal ions or metal atoms, respectively) as functional carriers are added to a solution of the nanoparticles 3. Through this second reaction step 200 the metal particles 4 incorporate into the inner of the nanoparticle 3, to be more exactly: within the polymer 1. Therewith, metal particles 4 are stabilized by the nanoparticle 3 in such a way that they can be kept soluble under conditions under which they would usually precipitate and would not be present in soluble form.

Thereby, the nanoparticle 3 has a size G, which corresponds to the projection of its mean diameter onto a plane. The size can, e.g., be determined by transmission electron microscopy. The size G of the nanoparticle 3 is in this exemplary embodiment 5 to 20 nm.

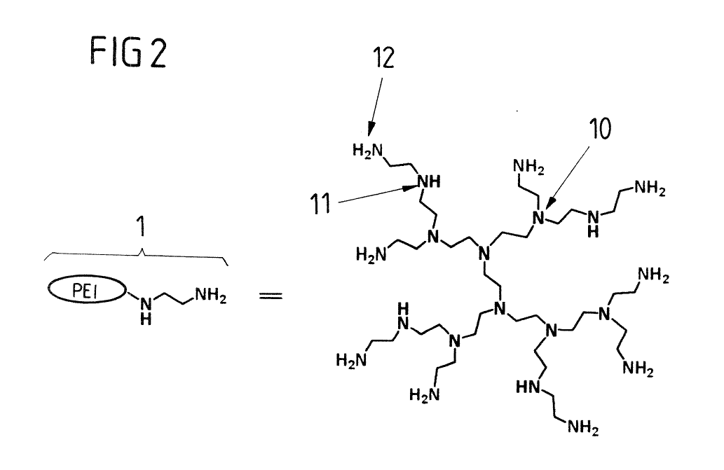

FIG. 2 shows the chemical structure of polyethyleneimine (PEI) as an example for the polymer 1. The polyethyleneimine has in its inner dendritic units 10 consisting of tertiary amines which are linked to each other. For better clearness, only one dendritic unit 10 of all dendritic units 10 is marked with a corresponding numeral reference.

The dendritic units 10 are joined by linear units 11 at the further outer parts of the structure of the polyethyleneimine, the linear units 11 consisting of secondary amine groups, wherein once again only a single linear unit 11 is marked with the corresponding numeral reference.

The linear units 11 are joined by terminal units 12 at the further outer parts of the structure of the polyethyleneimine, the terminal units 12 consisting of a primary amine in each case, wherein also only one terminal unit 12 is marked with the corresponding numeral reference in the structure of FIG. 2 for better clearness.

The terminal units 12 are particularly suited for the functionalization of the whole polyethyleneimine by according functional groups. As can be seen from the structure of FIG. 2, the polyethyleneimine forms, however, already without functionalization space areas being distinguishable from each other. Thus, the dendritic units 10 can also be considered as core of the polyethyleneimine and the terminal units 12 as shell of the polyethyleneimine, whereas the linear units 11 are to be understood as intermediate units.

I.e., a nanoparticle formed of the polyethyleneimine has already without functionalization of the polyethyleneimine a core (consisting of the dendritic units 10) and a shell (consisting of the terminal units 12). With reference to FIG. 1, a dendritic nanotransporter in form of a core-shell system can already be produced without a first reaction step 100. Such a nanotransporter or nanoparticle 3, respectively, could consequently direct being loaded with according metal particles 4 without further functionalization.

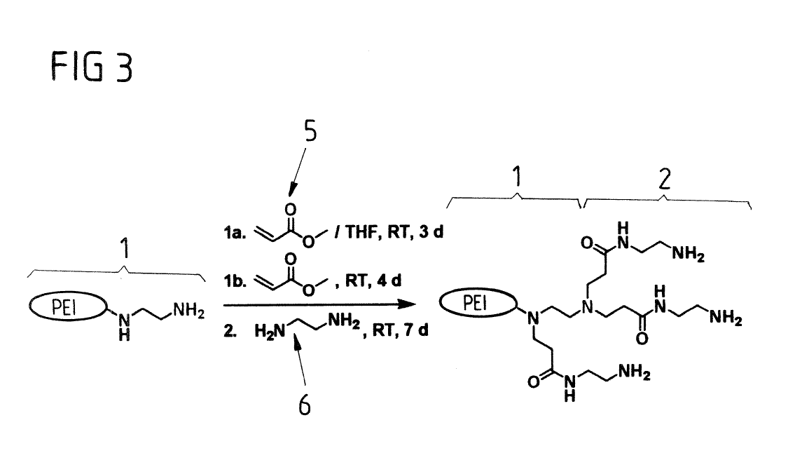

FIG. 3 shows the reaction equation of a functionalization of a polyethyleneimine already known from FIG. 2 as polymer 1 by an acrylic acid methyl ester 5 in a first and a second sub-step of a first functionalization reaction and with ethylene diamine 6 in a second functionalization reaction. The finally obtained product is a polyethyleneimine polyamidoamine (PEI-PAMAM) in which the polyethyleneimine residue serves as polymer 1 and the polyamidoamine residues serve as functional group 2. In an according nanoparticle, the polyethyleneimine residue forms the core and the polyamidoamine residues form the shell of the nanoparticle.

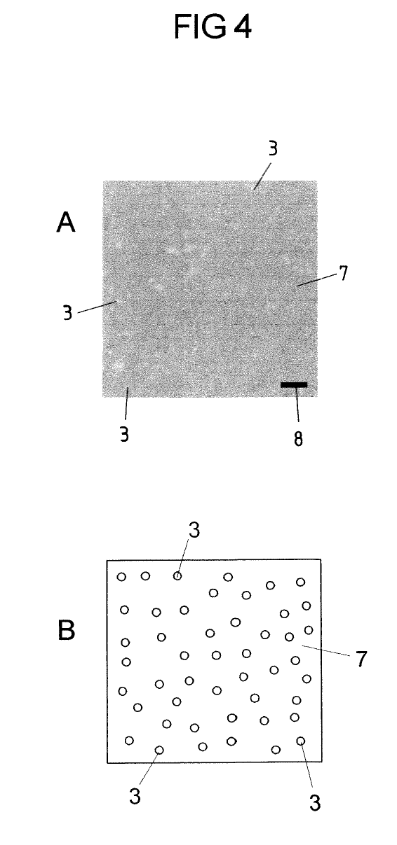

FIG. 4A shows an electron-microscopical photograph of a section through material system according to an exemplary embodiment of the invention. This material system consists of a nickel matrix 7 as matrix and nanoparticles 3 being essentially homogenous dispersed within the nickel matrix 7. The nanoparticles 3 have an average size, i.e. an average projected diameter, of approximately 2 to 20 nm, as can be estimated from the metering bar 8 measuring 200 nm in the lower right area of FIG. 4A.

For better clearness, only a few nanoparticles 3 of the numerous nanoparticles 3 embedded in the nickel matrix 7 are marked with the corresponding numeral reference. Some nanoparticles 3 appearing to be bigger do not constitute single nanoparticles 3, but an aggregation of several single nanoparticles 3. The electron-microscopical picture of a material system depicted in FIG. 4A constitutes an essentially uniform dispersion of nanoparticles 3 within a matrix 7 in the sense of the instant invention.

FIG. 4B is a schematic depiction of a detail of FIG. 4A and shows in a schematic way the essentially uniform dispersion of the nanoparticles 3, of which once again only a few are marked with the corresponding numeral reference, within the nickel matrix 7.

### Example 1

### Synthesis of polyethyleneimine polyamidoamine (PEI-PAMAM)

Besides non-functionalized polyethyleneimine (PEI), PEI functionalized with polyamidoamine (PEI-PAMAM) can be used as functionalized polymer for the production of nanoparticles.

A plurality of PEIs having different average molecular weights, e.g., having a molecular weight of 5 kDa or of 25 kDa, are suited as starting material.

Such PEI-PAMAM polymers can be produced in multigram preparations in amounts of more than 100 g. The rate of functionalization after the second reaction step (cf. FIG. 3) of PEI with PAMAM is approximately 90% and can be considered as completely branched analogously to dendrimers since also those contain defect structures.

PEI-PAMAM is soluble in, e.g., water, methanol and ethanol so that a plurality of application possibilities in different solvent results for nanoparticles made from PEI-PAMAM.

For the production of PEI-PAMAM, a solution of 5 g PEI (23.3 mmol·g⁻¹ N—H) in 80 ml THF and a few milliliters methanol is added dropwise to a mixture of 50 ml (0.55 mol) acrylic acid methyl ester and 25 ml tetrahydrofuran (THF) at room temperature (RT) within one hour.

After three days, the solvent is removed and the polymer is stirred in further 15 ml acrylic acid methyl ester 4 or 5 days at RT. Subsequently, the solvent is condensed off and the raw product, which is obtained in a yield of 95% as slightly yellow oil, is used without further purification for a subsequent second reaction step.

The raw product can be characterized by infrared spectroscopy (IR) by the following band in the IR spectrum: \tilde{v} (cm⁻¹)=1735 (C═O).

The raw product can be characterized by nuclear magnetic resonance spectroscopy (NMR) by the following resonances (the resonance causing groups or atoms, respectively, are depicted underlined):

¹H NMR (300 MHz, CDCl₃): δ (ppm)=2.33 [PEI-CH₂—CH₂COOCH₃], 2.2-2.5 [PEI-CH₂—CH₂—COO—CH₃], 2.67 [PEI-CH₂—CH₂—COO—CH₃], 3.55 [PEI-CH₂—CH₂—COO—CH₃];

¹³C NMR (75.4 MHz, CDCl₃): δ (ppm)=32.4 [PEI-CH₂—CH₂—COO—CH₃], 49.6 and 50.1 [PEI-CH₂—CH₂—COO—CH₃], 51.3 [PEI-CH₂—CH₂—COO—CH₃], 51-55 [PEI-CH₂—CH₂—COO—CH₃], 172.6 [PEI-CH₂—CH₂—COO—CH₃]

In the second reaction step, the raw product (which contains 116.5 mmol ester groups) is solved in 50 ml THF and added dropwise to 150 ml (2.25 mol) ethylene diamine at RT within 2 hours. THF is removed under slight vacuum and the reaction mixture is stirred for one week at RT.

The ethylene diamine is subsequently condensed off and the raw product is dialyzed in methanol for 36 hours (under two-times change of the solvent). The united contents of the dialysis tubes are removed at 40° C. temperature of the water bath and the PEI-PAMAM is obtained as sticky, slightly yellow colored product (yield after dialysis: 87%).

The product can be characterized by the following bands or resonances (the resonance causing groups or atoms, respectively, are once again depicted underlined:

IR: \tilde{v} (cm⁻¹)=1640 (C═O);

¹H NMR (300 MHz, D₂O): δ (ppm)=2.28 [PEI-CH₂—CH₂—CONH—CH₂—CH₂—NH₂], 2.4-2.8 [PEI-CH₂—CH₂—CONH—CH₂—CH₂—NH₂], 2.56 [PEI-CH₂—CH₂—CONH—CH₂—CH₂—NH₂], 2.66 [PEI-CH₂—CH₂—CONH—CH₂—CH₂—NH₂], 3.08 [PEI-CH₂—CH₂—CONH—CH₂—CH₂—NH₂];

¹³C NMR (75.4 MHz, CD₃OD, inverse gated): δ (ppm)=35.0 [N(T_{2×PAMAM}), N(L)-CH₂—CH₂—CONH—CH₂—CH₂—NH₂], 36.9 [defect, N(T_{1×PAMAM})-CH₂—CH₂—CONH—CH₂—CH₂—NH₂], 40.4 [PEI(T_{non-reacted})], 42.4 [PEI-CH₂—CH₂—CONH—CH₂—CH₂—NH₂], 43.4 [PEI-CH₂—CH₂—CONH—CH₂—CH₂—NH₂], 47.0 [defect, N(T_{1×PAMAM})—CH₂—CH₂—CONH—CH₂—CH₂—NH₂], 50-55 [PEI-CH₂—CH₂—CONH—CH₂—CH₂—NH₂], 176.8 [PEI-CH₂—CH₂-CONH—CH₂—CH₂—NH₂].

### Example 2

### Loading the Nanoparticles with Gold

Nanoparticles are formed from PEI-PAMAM produced according to example 1. Principally, also other polymers are suited for the production of nanoparticles loaded with gold, wherein, e.g., PEI having an average molecular weight of 25 kDa is better suited than PEI having an average molecular weight of 5 kDa. However, as compared to non-functionalized PEI, a greater stability of nanoparticles being produced from PEI-PAMAM according to example 1 can be observed.

The solved nanoparticles, i.e. the polymer solution, are mixed with the gold solution. A precipitate formed after the addition of the gold solution to the polymer solution dissolves after 3 to 4 days again. The concentration of the nanoparticulate polymer is 5·10⁻⁴ mol·l⁻¹. The concentration ratio between polymer and gold is approximately 1:24 and the pH value of the polymer solution is approximately 10.

Without addition of a reduction medium, red solutions are obtained; this can be attributed to the oxidation of amine groups. The gold incorporates into the nanoparticles presumably in atomic form. The nanoparticles loaded with gold are stable in electrolyte solutions in a pH range of from −1 to 14. Higher concentrated polymer solutions account for a smaller polymer-to-gold ratio or result in a lower long-term stability of the nanoparticles loaded with gold (under beneficial conditions, the nanoparticles loaded with gold are stable over several weeks or months).

### Example 3

### Electrolytic Deposition of Nanoparticles Loaded with Gold

A few milliliters of the obtained solution of nanoparticles loaded with gold according to example 2 are added to a nickel electrolyte. The concentration ratio of polymer to gold is 1:24. The concentration of the used polymer solution is 6.25·10⁻⁴ mol·l⁻¹. The nanoparticles loaded with gold are stable in the nickel electrolyte at a 1:1 mixture between nanoparticles and nickel electrolyte and a pH value of 4 to 5.

The deposition of the nickel ions as nickel atoms (for the formation of the matrix) together with the nanoparticles loaded with gold takes place at a copper electrode as a substrate at a current density of 5 A/dm² and a temperature of 40° C.

For uniform deposition over the whole surface of the copper electrode, the copper electrode is moved or rotated, respectively, at a rotational velocity of approximately 2 000 rpm in the nickel electrolyte solution which contains the nanoparticles loaded with gold. The result of the uniform deposition can be seen in FIG. 4.

Whereas usual coatings of gold (having a cobalt proportion of usually 0.8%) onto a substrate (e.g., of copper) have coating thicknesses of approximately 0.8 μm, nickel coatings having a coating thickness of 1.2 μm, in which nanoparticles loaded with gold are uniformly dispersed, can be produced according to an embodiment of the invention. Therewith, the material effort of gold is reduced by a multiple. Thus, the homogenous nanoparticulate gold dispersion in metal matrix systems results in an enormous material saving since the same or even a better effect as with a classic gold coating can be achieved partly with significantly thinner layers but in particular with less noble metal.

Additionally, thinner gold layers act as a layer of a dry-film lubricant. During a successive abrasion of the nickel layer, which is interspersed with nanoparticles loaded with gold, the property of the nickel layer with respect to this dry-film lubricant effect but also with respect to the conductivity value is not changed. Such a successive abrasion can, e.g., occur if a plug rubs back and forth in a plug-receiving coupling due to vibrations or the like.

With material systems according to an aspect of the invention, in particular the production of novel functional surfaces can be achieved. Thereby, an optimization of the properties is particularly provided with respect to abrasion, hardness, insertion force, transition resistance, temperature consistency. These properties have, e.g., essential impacts on the weight, the long-term stability, the functional safety as well as the material effort in all mobile electronic applications. E.g., a significant fuel saving can be achieved in a motor vehicle by weight reduction of connector assemblies. A lower abrasion and the longer lifetime of the connector contacts connected therewith reduces the emergence of electronic scrap and reduces the material and energy effort for the contacts to be replaced.

By the exemplary embodiment of the invention in the area of connector assemblies, the potential of material systems according to an aspect of the invention can be demonstrated exemplary, wherein a transfer of according results onto almost all electrochemically produced metal systems is thinkable. Besides the formation of multiphase systems, the production of granular systems, dispersion-hardened composite materials as well as multi-component alloy systems produced by phase formation can be made possible by the use of nanoparticles loaded with metals.

1-39. (canceled)

40. A material system having a matrix and nanoparticles embedded therein, wherein
the matrix comprises at least one matrix metal,
the nanoparticles have an average size of less than 50 nm and
the nanoparticles have in each case at least one functional carrier.

41. The material system according to claim 40, wherein the nanoparticles in each case have at least one polymer.

42. The material system according to claim 41, wherein the polymer is a dendritically structured polymer.

43. The material system according to claim 41, wherein the polymer is polyethyleneimine, polyamidoamine and/or polypropyleneimine.

44. The material system according to claim 41, wherein the polymer has a functional group.

45. The material system according to claim 44, wherein the functional group consists of the residue of a hydrocarbon compound, in particular of the residue of glycidol, gluconolactone and/or lactobionic acid, and/or of the residue of a polymer, in particular of polyethyleneimine, polyamidoamine and/or polypropyleneimine.

46. The material system according to claim 41, wherein the nanoparticles in each case have a core which is at least partially surrounded by a shell.

47. The material system according to claim 46, wherein the core and the shell are formed by the polymer.

48. The material system according to claim 46, wherein the core is formed by the polymer and the shell is formed by the functional group.

49. A component, in particular an electric or electronic component, having a coating which has a material system according to claim 40.

50. A method for producing a material system according to claim 40 on a substrate, having the following steps:
providing a substrate,
providing an electrolyte solution which has ions of a matrix metal,
producing nanoparticles, wherein the nanoparticles have an average size of less than 50 nm,
loading the nanoparticles with at least one functional carrier,
drugging the electrolyte solution with the loaded nanoparticles,
dipping the substrate into the electrolyte solution drugged with nanoparticles and
depositing the ions of the matrix metal and of the loaded nanoparticles contained in the electrolyte solution as material system onto the substrate.

51. The method according to claim 50, wherein during deposition a relative movement between the substrate and the electrolyte is carried out.

52. The method according to claim 51, wherein the velocity of the relative movement is in a range of between 0 and 15 m/s, in particular of between 0.1 and 5 m/s and especially of between 0.1 and 2 m/s.

53. The method according to claim 50, wherein the substrate forms an electrode which has a metal.

54. The method according to claim 53, wherein the metal is chosen from the group consisting of platinum, gold, silver, copper, cobalt, nickel, iron, tin and palladium.

55. The method according to claim 50, wherein the substrate is a component, in particular an electric or electronic component.

56. The method according to claim 55, wherein the component is an electrically conductive portion of a plug.

57. The method according to claim 50, wherein it comprises an additional step of aftertreatment of the material system deposited onto the substrate after the deposition.
